(19) United States
(12) Patent Application Publication
(10) Pub. No.: US 2025/0144647 A1
(43) Pub. Date: May 8, 2025

(54) HANDHELD SHOWERHEAD AND SHOWERHEAD ASSEMBLY

(71) Applicant: Xiamen Songyu Plumbing Co., Ltd, Xiamen (CN)

(72) Inventors: HEWEI LIU, Xiamen (CN); WEIFENG ZENG, Xiamen (CN); RUIQIANG ZHANG, Xiamen (CN)

(21) Appl. No.: 18/412,539

(22) Filed: Jan. 14, 2024

(30) Foreign Application Priority Data
Nov. 2, 2023 (CN) 202322959275.5
Nov. 2, 2023 (CN) 202322964955.6

(51) Int. Cl. B05B 1/18; B05B 1/16; B05B 15/40

(52) U.S. Cl. CPC B05B 1/18; B05B 1/1627; B05B 1/169; B05B 15/40

(57) ABSTRACT

The present disclosure provides a handheld showerhead and showerhead assembly comprising the handheld showerhead. The handheld showerhead comprises a water passing component, a first water outlet component, a second water outlet component, a switching component. The switching component of the present disclosure can be used in different shapes of the handheld showerhead; and has a small rotation stroke which makes it easier for the user to switch. The handheld showerhead can be fixed in the top spray showerhead without additional socket.

### TECHNICAL FIELD

The present disclosure relates to a handheld showerhead and showerhead assembly comprising the handheld showerhead.

### BACKGROUND

There are many functional forms of square structures showerheads with curved chamfers. Currently, more and more showerheads with spray gun functions and multiple types of water outlets are being developed, which requires a powerful switching structure. Many showerheads switch water flow by rotating the face cover. However, a square shaped showerhead cannot be achieved by the above rotating face cover. In addition, the existing switch structure for directly rotating the face cover has a large rotation stroke, which makes it harder for the user to switch.

### SUMMARY OF THE DISCLOSURE

The present disclosure provides a handheld showerhead and showerhead assembly comprising the handheld showerhead.

In a first aspect, the present disclosure provides a handheld showerhead comprising:
a water passing component, a first water outlet component, a second water outlet component, and a switching component;
the water passing component comprises a first body having a water inlet end, a water outlet end, a first channel located between the water inlet end and the water outlet end, and a first cavity located on the water outlet end; the water passing component further comprises a second body located in the first cavity and connected to the water outlet end; the second body comprises a first water passing channel connecting to the second water outlet component, and a second water passing channel connecting to the first water outlet component;
the water passing component further comprises an upper component located near the main body, a lower component located far away from the main body and fixes on the upper component, and a water separating element; the upper component comprises a third opening connected to the second water passing channel, the lower component comprises a forth opening connected to the third opening, and a first cylinder; the water separating element comprises an installing hole for accommodating the first cylinder and a plurality of water separating holes uniformly distributed on an arc centered of the axis of the installing hole; the switching component comprises a handle fixes on the first cylinder.

In a second aspect, the present disclosure provides a handheld showerhead, which comprises:
a handheld showerhead and a top spray showerhead; the top spray showerhead comprises a storage groove for accommodating the handheld showerhead without additional socket;
wherein, the handheld showerhead, comprising:
a water passing component, a first water outlet component, a second water outlet component, a switching component;
the water passing component comprises a first body having a water inlet end, a water outlet end, a first channel located between the water inlet end and the water outlet end, and a first cavity located on the water outlet end; the water passing component further comprises a second body located in the first cavity and connected to the water outlet end; the second body comprises a first water passing channel connecting to the second water outlet component, and a second water passing channel connecting to the first water outlet component;
the water passing component further comprises an upper component located near the main body, a lower component located far away from the main body and fixes on the upper component, and a water separating element; the upper component comprises a third opening connected to the second water passing channel, the lower component comprises a forth opening connected to the third opening, and a first cylinder; the water separating element comprises an installing hole for accommodating the first cylinder and a plurality of water separating holes uniformly distributed on an arc centered of the axis of the installing hole; the switching component comprises a handle fixes on the first cylinder.

From the above description of the present disclosure, it may be seen that the present disclosure has many beneficial effects.

For example, the switching component can be used in different shapes of the handheld showerhead, and has a small rotation stroke which makes the user easily to switch.

In another example, the handheld showerhead can be fixed in the top spray showerhead without an additional socket, thus making the bathroom space more concise.

### BRIEF DESCRIPTION OF THE DRAWINGS

The accompanying drawings described here are intended to provide a further understanding of the present disclosure and form a part of the present disclosure. The schematic embodiments and explanations of the present disclosure are configured to explain the present disclosure and do not constitute an improper limitation of the present disclosure.

FIG. 1 shows a structural view of a handheld showerhead of one embodiment.

FIG. 2 shows another structural view of the handheld showerhead of FIG. 1.

FIG. 3 shows exploded views of the handheld showerhead of FIG. 1.

FIG. 4 shows partial enlarged views of FIG. 3.

FIG. 5 shows cross-sectional view of the handheld showerhead of FIG. 1.

FIG. 6 shows another cross-sectional view of the handheld showerhead of FIG. 1.

FIG. 7 shows a structural view of a showerhead assembly of one embodiment.

FIG. 8 shows exploded views of the showerhead assembly of FIG. 7.

FIG. 9 shows another exploded views of the showerhead assembly of FIG. 7.

FIG. 10 shows a main view of the showerhead assembly of FIG. 7.

FIG. 11 shows a top view of the showerhead assembly of FIG. 7.

FIG. 12 shows a top exploded view of the showerhead assembly of FIG. 7.

FIG. 13 shows a partial three-dimensional structural view of the showerhead assembly of FIG. 7.

### DETAILED DESCRIPTION

In order to make the technical problems, technical solutions, and beneficial effects to be solved by the present disclosure clearer, the present disclosure may be further explained in detail in conjunction with the accompanying drawings and embodiments. It should be understood that the specific embodiments described here are only intended to explain the present disclosure and are not intended to limit the present disclosure.

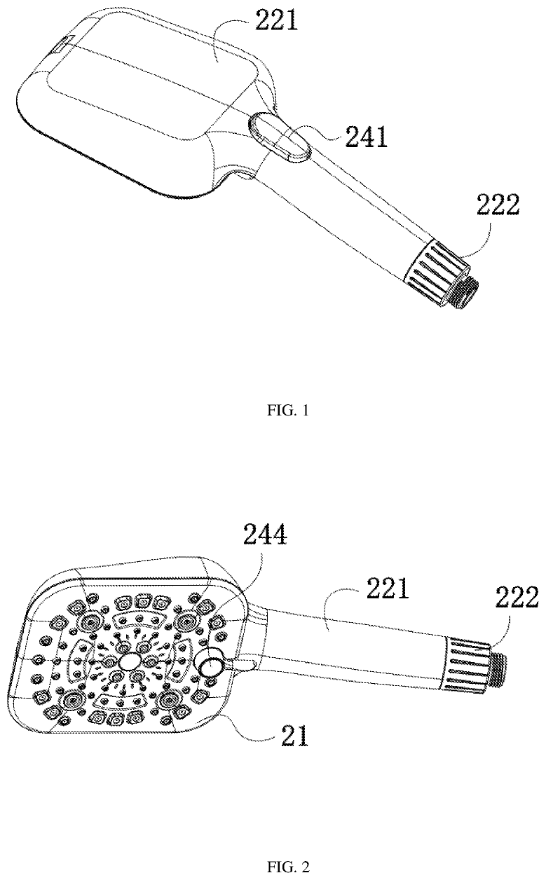

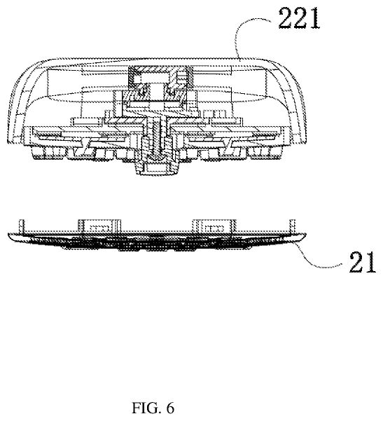

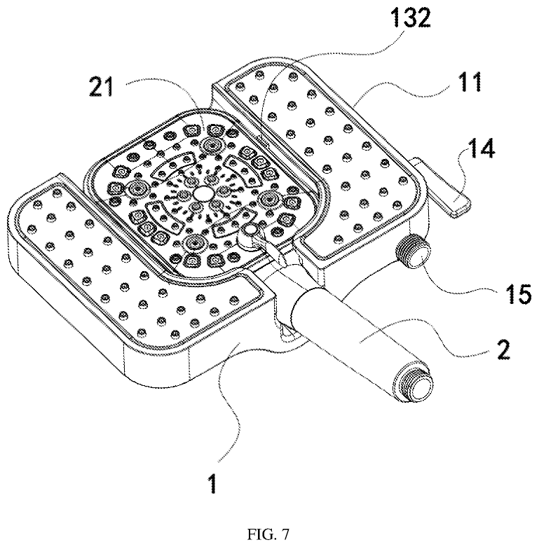

Referring to FIGS. 1 to 6, a handheld showerhead 2 of one embodiment is provided. The handheld showerhead 2 comprises a water passing component 22, a first water outlet component 21, a second water outlet component 25, a switching component 24, and a filtering component 23 located in the water passing component 22. The water flows from an inlet end of the water passing component 22, filtered by the filtering component 23, and flows out of an outlet end of the water passing component 22; and then switched to flow to the first water outlet component 21 or the second water outlet component 25 by the control of the switching component 24. The first water outlet component 21 forms a front cover of the handheld showerhead 2. And the water passing component 22 forms a back cover of the handheld showerhead 2. In one embodiment, the handheld showerhead 2 is a square structure with curved chamfers.

The water passing component 22 comprises a first body 221 having a water inlet end, a water outlet end and a first channel located there between and a first cavity located on the water outlet end. The water passing component 22 further comprises a detachable water inlet joint 222 located on the water inlet end of the first body 221. In one embodiment, the detachable water inlet joint 222 comprises first internal threads, and the water inlet end of the first body 221 comprises first external threads corresponding to the first internal threads. A sealing ring is further located between first body 221 and the detachable water inlet joint 222 to ensure that there is no water leakage. The detachable water inlet joint 222 further comprises a second external threads, which is used to connect the external component.

The filtering component 23 is located in the first channel of the first body 221 and can be disassembled and replaced. And end of the filtering component 23 extends out of the water inlet end of the first body 221 for easy replacement and removal. The filtering component 23 is out of service, the filtering component 23 can be unplugged and replaced.

The water passing component 22 further comprises a second body 227 located in the first cavity of the first body 221 and connected to the filtering component 23. The second body 227 comprises a first water passing channel connecting to the second water outlet component 25, and a second water passing channel connecting to the first water outlet component 21. In one embodiment, the second water outlet component 25 is a spray gun, and the first water outlet component 21 is a shower water outlet cover. The second body 227 comprises a switching hole located at the intersection of the first water passing channel and the second water passing channel, and a switching valves 242 further locates at the switching hole. The water outlet end of the first body 221 can be selectively connected to the first water passing channel or the second water passing channel by pressing the switching valves 242.

The first body 221 further comprises a first opening corresponding to the switching hole, and the switching valves 242 protrudes through the first opening of the first body 221 and connects to a button 2241. The water outlet end of the first body 221 can be selectively connected to the first water passing channel or the second water passing channel by pressing the button 2241. The first body 221 further comprises a second opening, and the second water outlet component 25 protrudes through the second opening of the first body 221.

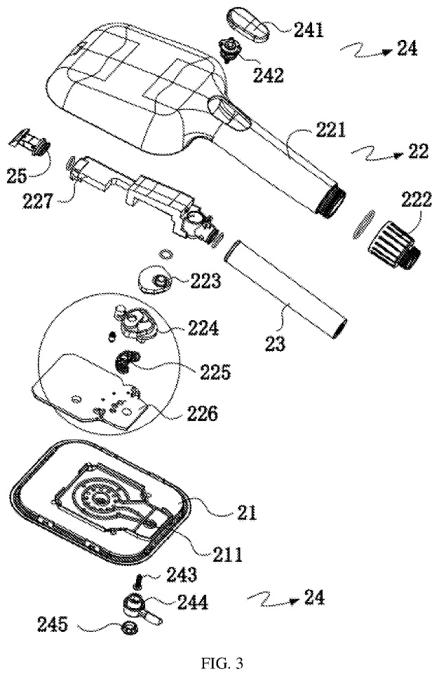

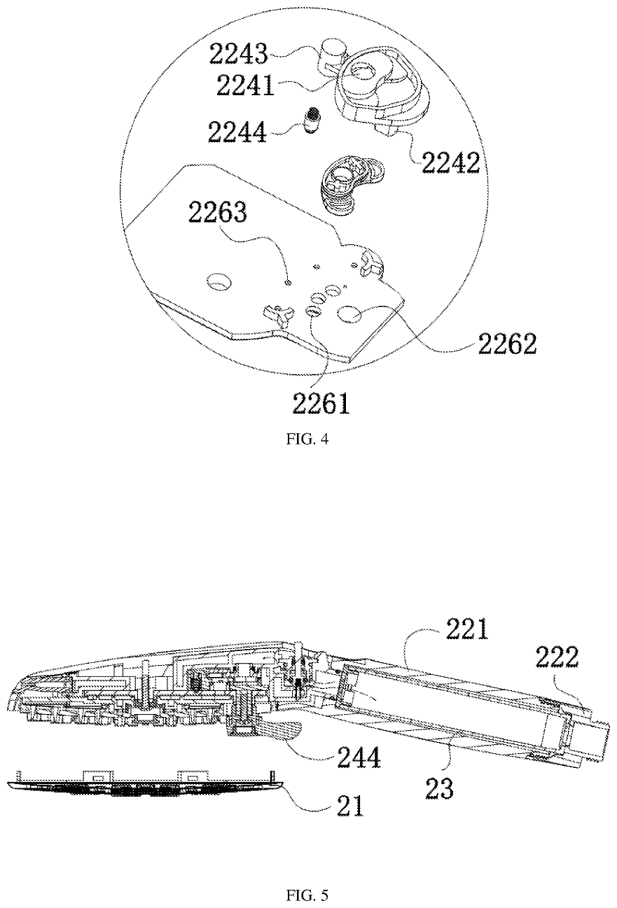

The water passing component 22 further comprises a water passing element connecting to the second water passing channel. Referring to FIGS. 3 to 4, the water passing element comprises an upper component 223 located near the main body 227, and a lower component 224 located far away from the main body 227. The upper component 223 and the lower component 224 cover together to form an entire structure. In one embodiment, the upper component 223 and the lower component 224 cover together by welding. In other embodiment, the upper component 223 and the lower component 224 cover together by insertion sections there between.

The upper component 223 comprises a third opening connected to the second water passing channel, and the lower component 224 comprises a forth opening 2241 connected to the third opening. The lower component 224 further comprises a containment groove and a first cylinder 2242 both located on a surface of the lower component 224 away from the upper component 223. The containment groove is connected with the forth opening 2241. An irregular sealing pad 225 is located in the containment groove, a shape of the irregular sealing pad 225 fits with a shape of the containment groove. The irregular sealing pad 225 is a circular arc structure with lower sides and higher middle, and has a fifth opening corresponding to the forth opening 2241. A distance between an axis of the forth opening 2241 and an axis of the first cylinder 2242 is defined as L1.

The water passing component 22 further comprises a water separating element 226 located below the lower component 224. The water separating element 226 comprises an installing hole 2262 and a plurality of water separating holes 2261. The plurality of water separating holes 2261 are uniformly distributed on an arc centered on the axis of the installing hole 2262. A distance between adjacent two water separating holes 2261 is equal. A distance between an axis of the installing hole 2262 and an axis of the water separating holes 2261 is defined as L2. Wherein, in one embodiment, L1 is equal to L2. The first cylinder 2242 installs in the installing hole 2262, and can rotate around the installing hole 2262. When the water passing element rotates around the installing hole 2262, the forth opening 2241 can be selectively connected to one of the plurality of water separating holes 2261.

The distance between adjacent two water separating holes 2261 is defined as L3. In some embodiments, L3 ranges from 1.2 mm˜2.5 mm, to make sure that the strength between the adjacent two water separating holes 2261 is strong enough. Furthermore, because distance between adjacent two water separating holes 2261 is small, thus a switching distance of the forth opening 2241 switching from one of the water separating holes 2261 to the other water separating holes 2261 can be reduced. Allow users to operate with one hand, and enhance user experience. In some embodiment, L3 ranges from 1.5 mm˜2.2 mm. In one embodiment, L3 is about 1.83 mm. Furthermore, a line B is formed between the axis of each water separating holes 2261 and the axis of the installing hole 2262. An angle C between adjacent line B ranges from 30° to 40°. In some embodiment, the angle C ranges from 30° to 35°, so as to facilitate operating. In one embodiment, the angle C is about 32°.

The lower component 224 further comprises a second cylinder 2243 located on a side of the lower component 224 away from the first cylinder 2242. The second cylinder 2243 comprises a cylindrical cavity located on a surface away from the upper component 223. An axis of the first cylinder 2242, an axis of the forth opening 2241, and an axis of the cylindrical cavity are located on the same straight line. The lower component 224 further comprises a movable element 2244 located in the cylindrical cavity. The movable element 2244 comprises a movable pillar and a spring sleeved on an end of the movable pillar. The spring is located between the cylindrical cavity and the movable pillar, and pushes the movable pillar towards the water separating element 226. The water separating element 226 further comprises a plurality of positioning hole 2263, which is corresponding to the water separating holes 2261 respectively. An axis of the positioning hole 2263, an axis of the water separating holes 2261, and an axis of the installing hole 2262 are located on the same straight line. When the water passing element rotates around the installing hole 2262, the movable pillar can be pushed towards the water separating element 226 by the spring and partial accommodated in the corresponding positioning hole 2263 to form different gear positions.

A plurality of water diversion channels spaced with each other is formed on a surface of the water separating element 226 away from the lower component 224. Each of the water diversion channels is corresponding to a water separating hole 2261.

The first water outlet component 21 is located under the water separating element 226, and comprises a plurality of water outlet channels corresponding to the plurality of water diversion channels. The first water outlet component 21 comprises a sixth holes 211 corresponding to the installing hole 2262. The sixth holes 211 and the installing hole 2262 share the same axis A.

The switching component 24 comprises a handle 244. The handle 244 inserts into the sixth holes 211 and passes through the installing hole 2262 and finally fixes on the first cylinder 2242 by a screw 243. The switching component 24 further comprises cover 245 decorating on the screw 243.

When the handle 244 is operated by the user, the first cylinder 2242 can rotates around the axis A, and then drives the water passing element rotating around the axis A.

A diameter of the water separating holes 2261 ranges from 4 mm˜6.5 mm. In some embodiment, the diameter of the water separating holes 2261 ranges from 4.5 mm˜6 mm. In one embodiment, the diameter of the water separating holes 2261 is about 5 mm.

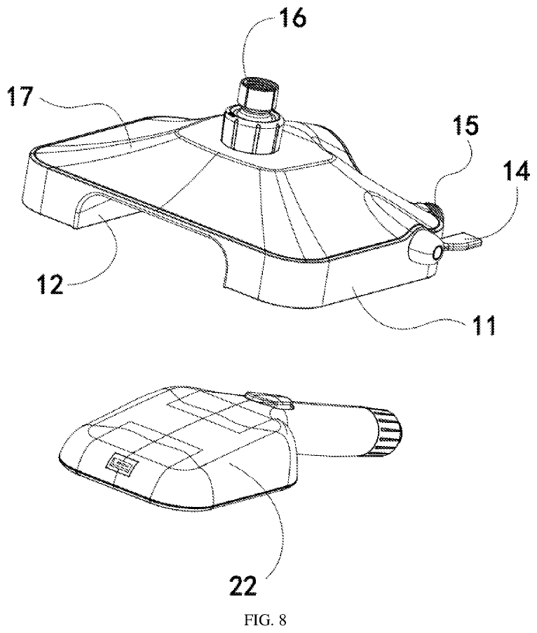

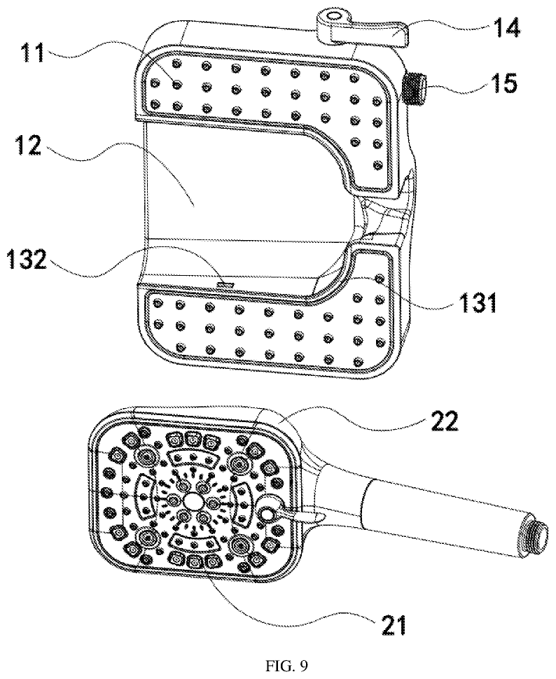

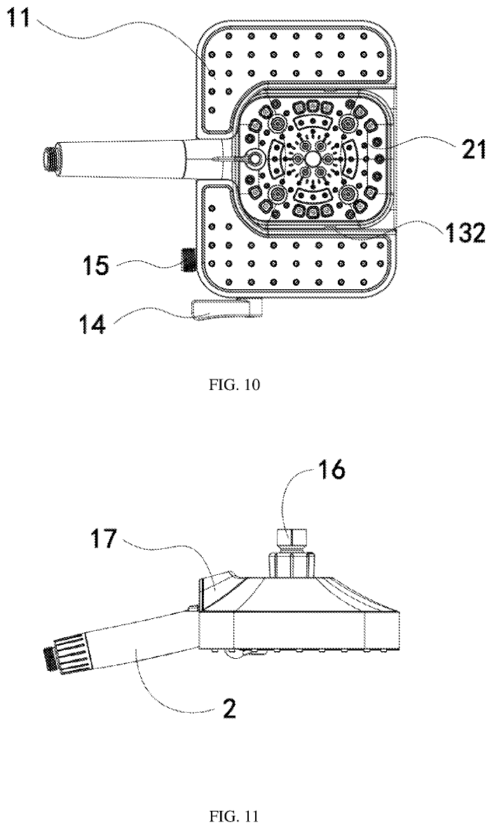

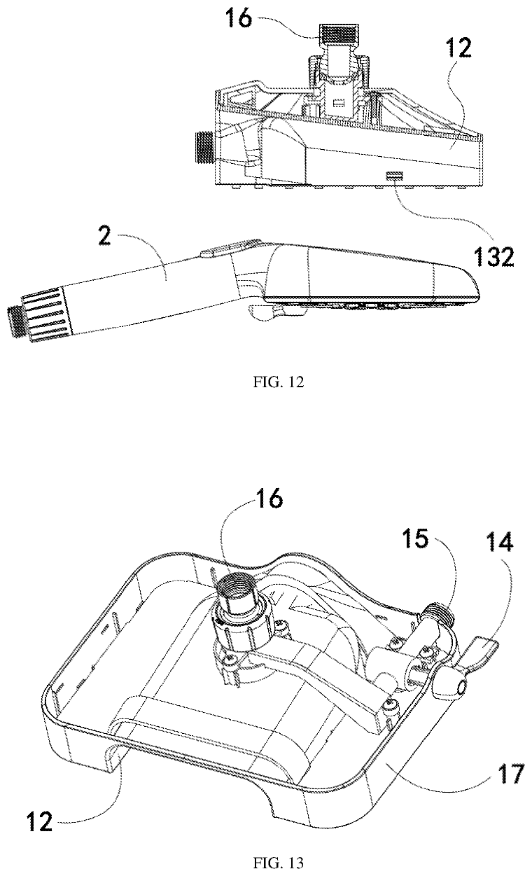

Referring to FIGS. 7 to 13, a showerhead assembly comprising the above handheld showerhead 2 of one embodiment is provides. The showerhead assembly comprises the handheld showerhead 2 and a top spray showerhead 1. The top spray showerhead 1 comprises a storage groove 12 for accommodating the handheld showerhead 2 without additional socket.

The top spray showerhead 1 comprises a water outlet penal 11, a water passing unit located in the water outlet penal 11, a top cover 17 covered on the water outlet penal 11, a switching member 14 located on a side of the water outlet penal 11. The water passing unit comprises a water outlet path, a water inlet member 16 and a water passing member 15 located in the water outlet path. The top cover 17 comprises a first through-hole, and the water inlet member 16 protrudes through the first through-hole. The water passing member 15 locates at a side of the water outlet penal 11. The showerhead assembly further comprises a flexible pipe connected between the water passing member 15 and the handheld showerhead 2, and provides the water to the handheld showerhead 2.

The switching member 14 can be fixed on the right side or the left side of the water outlet penal 11 according to different needs of the user.

The storage groove 12 can be located on a surface of the water outlet penal 11 away from the water inlet member 16. A shape of the handheld showerhead 2 is consistent with the shape of the storage groove 12, so that the handheld showerhead 2 detachably accommodated in the storage groove 12. The switching member 14 is used to switch the water flowing from the handheld showerhead 2 or the top spray showerhead 1. When the switching member 14 connects the water passing member 15 and the handheld showerhead 2, the water flowing from the handheld showerhead 2. When the switching member 14 connects the water outlet path of the water passing unit to the water outlet penal 11, the water flowing from the top spray showerhead 1.

The top spray showerhead 1 further comprises a positioning assembly 13 located a surface of the storage groove 12, to enable the handheld showerhead 2 to be stably installed in the storage groove 12. The positioning assembly 13 comprises a plurality of positioning bulges 131 located a surface of the storage groove 12, for stably snapping the handheld showerhead 2. In one embodiment, the positioning assembly 13 comprises two positioning bulges 131 located different sides of the storage groove 12.

A surface of the water outlet penal 11 is greater than a surface of the first water outlet component 21. In some embodiment, the surface of the water outlet penal 11 is about 1.5˜3 times greater than the surface of the first water outlet component 21.

Referring to FIGS. 7, 10 and 11, the surface of the water outlet penal 11 and the surface of the first water outlet component 21 are located on the same plane. And the handheld showerhead 2 is located in the middle of the top spray showerhead 1, and the storage groove 12 divides the water outlet penal 11 into a first water outlet portion and a second water outlet portion. Referring to FIG. 10, the first water outlet portion and the second water outlet portion are symmetric located and surround the three sides of the handheld showerhead 2, so that the handheld showerhead 2 can firmly located in the storage groove 12. The water outlet penal 11 further comprises an abdication position for accommodating the first body 221 and further make the handheld showerhead 2 firmly located in the storage groove 12.

The positioning assembly 13 further comprises a plurality of elastic blocks 132 scattered located on the surface of the storage groove 12. The plurality of elastic blocks 132 are spaced from each other. The first water outlet component 21 can be hooked onto the elastic block 132, and the handheld showerhead 2 can be securely inserted into the storage groove 12. In one embodiment, the positioning assembly 13 comprises two elastic blocks 132 scattered located on two side surface of the storage groove 12.

Sidewalls of the first water outlet portion and a second water outlet portion adjacent to the handheld showerhead 2 are inclined surfaces, which guides the handheld showerhead 2 to be easily clamped to the elastic block 132. The elastic blocks 132 are step structure, and rounded corners are set between each step.

In some embodiment, the surface of the water outlet penal 11 and the surface of the first water outlet component 21 are located on different planes. In one embodiment, the surface of the first water outlet component 21 are lower than the surface of the water outlet penal 11. In some embodiment, the surface of the first water outlet component 21 are 3 mm to 10 mm lower than the surface of the water outlet penal 11.

The above exemplary description of the present disclosure is provided in conjunction with the accompanying drawings. It is evident that the specific implementation of the present disclosure is not limited by the aforementioned modes. As long as various non substantial improvements are made using the method concept and technical solutions of the present disclosure, or when the concept and technical solutions of the present disclosure are directly applied to other occasions without improvement, they are all within the scope of protection of the present disclosure.

What is claimed is:

1. A handheld showerhead, comprising:
a water passing component, a first water outlet component, a second water outlet component, and a switching component;
the water passing component comprises a first body having a water inlet end, a water outlet end, a first channel located between the water inlet end and the water outlet end, and a first cavity located on the water outlet end; the water passing component further comprises a second body located in the first cavity and connected to the water outlet end; the second body comprises a first water passing channel connecting to the second water outlet component, and a second water passing channel connecting to the first water outlet component;
the water passing component further comprises an upper component located near the main body, a lower component located far away from the main body and fixes on the upper component, and a water separating element; the upper component comprises a third opening connected to the second water passing channel, the lower component comprises a forth opening connected to the third opening, and a first cylinder; the water separating element comprises an installing hole for accommodating the first cylinder and a plurality of water separating holes uniformly distributed on an arc centered of the axis of the installing hole; the switching component comprises a handle fixes on the first cylinder.

2. The handheld showerhead according to claim 1, wherein a distance between adjacent two water separating holes ranges from 1.2 mm˜2.5 mm.

3. The handheld showerhead according to claim 1, wherein lines B are formed between the axis of each water separating holes and the axis of the installing hole, an angle C between adjacent lines B ranges from 30° to 40°.

4. The handheld showerhead according to claim 1, wherein a diameter of the water separating holes ranges from 4.5 mm˜6 mm.

5. The handheld showerhead according to claim 1, wherein a distance between an axis of the forth opening and an axis of the first cylinder is equal to a distance between an axis of the installing hole and an axis of the water separating holes.

6. The handheld showerhead according to claim 5, wherein the lower component further comprises a second cylinder located on a side of the lower component; the second cylinder comprises a cylindrical cavity located on a surface away from the upper component; an axis of the first cylinder, an axis of the forth opening, and an axis of the cylindrical cavity are located on the same straight line; the lower component comprises a movable element located in the cylindrical cavity; the movable element comprises a movable pillar and a spring sleeved on an end of the movable pillar;
the spring is located between the cylindrical cavity and the movable pillar, and pushes the movable pillar towards the water separating element; the water separating element further comprises a plurality of positioning hole corresponding to the water separating holes respectively; an axis of the positioning hole, an axis of the water separating holes, and an axis of the installing hole are located on the same straight line.

7. The handheld showerhead according to claim 1, wherein the second body comprises a switching hole located at the intersection of the first water passing channel and the second water passing channel, and a switching valves further locates at the switching hole; the first body further comprises a first opening corresponding to the switching hole, and the switching valves protrudes through the first opening of the first body and connects to a button.

8. The handheld showerhead according to claim 1, wherein, the lower component further comprises a containment groove located on a surface of the lower component away from the upper component, the containment groove is connected with the forth opening; an irregular sealing pad is located in the containment groove, a shape of the irregular sealing pad fits with a shape of the containment groove.

9. The handheld showerhead according to claim 8, wherein the irregular sealing pad is a circular arc structure with lower sides and higher middle, and has a fifth opening corresponding to the forth opening.

10. The handheld showerhead according to claim 1, wherein the handheld showerhead comprises a filtering component located in the water passing component.

11. A showerhead assembly, comprising:
a handheld showerhead and a top spray showerhead, wherein the top spray showerhead comprises a storage groove for accommodating the handheld showerhead without additional socket;
the handheld showerhead, comprising:
a water passing component, a first water outlet component, a second water outlet component, a switching component;
the water passing component comprises a first body having a water inlet end, a water outlet end, a first channel located between the water inlet end and the water outlet end, and a first cavity located on the water outlet end; the water passing component further comprises a second body located in the first cavity and connected to the water outlet end; the second body comprises a first water passing channel connecting to the second water outlet component, and a second water passing channel connecting to the first water outlet component;
the water passing component further comprises an upper component located near the main body, a lower component located far away from the main body and fixes on the upper component, and a water separating element; the upper component comprises a third opening connected to the second water passing channel, the lower component comprises a forth opening connected to the third opening, and a first cylinder; the water separating element comprises an installing hole for accommodating the first cylinder and a plurality of water separating holes uniformly distributed on an arc centered of the axis of the installing hole; the switching component comprises a handle fixes on the first cylinder.

12. The showerhead assembly according to claim 11, wherein the top spray showerhead comprises a water outlet penal, a water passing unit located in the water outlet penal, a top cover covered on the water outlet penal, a switching member located on a side of the water outlet penal; the water passing unit comprises a water outlet path, a water inlet member and a water passing member located in the water outlet path; the top cover comprises a first through-hole, and the water inlet member protrudes through the first through-hole.

13. The showerhead assembly according to claim 12, wherein the top spray showerhead further comprises a positioning assembly located a surface of the storage groove, to enable the handheld showerhead to be stably installed in the storage groove.

14. The showerhead assembly according to claim 12, wherein a surface of the water outlet penal is 1.5˜3 times greater than a surface of the first water outlet component.

15. The showerhead assembly according to claim 14, wherein the surface of the water outlet penal and the surface of the first water outlet component are located on the same plane.

16. The showerhead assembly according to claim 14, wherein the surface of the first water outlet component are lower than the surface of the water outlet penal.

17. The showerhead assembly according to claim 13, wherein the positioning assembly further comprises a plurality of elastic blocks scattered located on the surface of the storage groove.

18. The showerhead assembly according to claim 12, wherein the showerhead assembly further comprises a flexible pipe connected between the water passing member and the handheld showerhead, and provides the water to the handheld showerhead.
